(19) United States
(12) Patent Application Publication
(10) Pub. No.: US 2021/0387057 A1
(43) Pub. Date: Dec. 16, 2021

(54) GOLF BALL AND METHOD OF MANUFACTURE

(71) Applicant: Bridgestone Sports Co., Ltd., Tokyo (JP)

(72) Inventor: Katsunobu MOCHIZUKI, Chichibushi (JP)

(73) Assignee: Bridgestone Sports Co., Ltd., Tokyo (JP)

(21) Appl. No.: 17/307,110

(22) Filed: May 4, 2021

(30) Foreign Application Priority Data
Jun. 11, 2020 (JP) 2020-101512

(51) Int. Cl. A63B 37/00; B29D 99/00

(52) U.S. Cl. CPC A63B 37/0039; A63B 37/0094; B29L 2031/546; B29D 99/0042; A63B 37/0093

(57) ABSTRACT

A golf ball is provided that includes at least one porous resin layer formed of a resin composition containing a polymeric material and a leachable water-soluble polymer. In a method for producing the golf ball, a resin composition containing the polymeric material and the water-soluble polymer is molded to form a solid molded body, following which the water-soluble polymer is partially leached out and removed. The golf ball has an improved ball controllability on approach shots and an improved feel at impact, maintains a good scuff resistance and has a good moldability.

### CROSS-REFERENCE TO RELATED APPLICATION

This non-provisional application claims priority under 35 U.S.C. § 119(a) on Patent Application No. 2020-101512 filed in Japan on Jun. 11, 2020, the entire contents of which are hereby incorporated by reference.

### TECHNICAL FIELD

The present invention relates to a golf ball having at least one resin layer with porosity, and to a method for manufacturing the golf ball.

### BACKGROUND ART

Golf balls are required to have, among other characteristics, a good flight and stopping performance and a good scuff resistance. That is, golf balls have been developed so as to fly well on shots with a driver and also be receptive to backspin on approach shots. For this reason, many cover materials with a high resilience and a good scuff resistance have been developed as golf ball members. However, when the resilience and scuff resistance of a golf ball member such as the cover are increased, the ball often ends up flying too far on approach shots and lacks a delicate controllability. Methods such as that of lowering the molecular weight have been studied as a way to lower the rebound resilience of the cover and other golf ball members. However, lowering the molecular weight tends to worsen the scuff resistance and moldability of the cover material. Accordingly, there exists a desire among professional golfers and skilled amateurs for a golf ball which, in addition to having a golf ball member such as a cover of high resilience and good scuff resistance, also is endowed with a better controllability on approach shots.

Art in which the cover member used in a golf ball is a foam body (porous body) has hitherto been described in a number of patent publications, including JP-A 2005-46299 and JP-A H01-212577. However, in such art, a blowing agent such as an organic blowing agent or sodium hydrogen carbonate (sodium bicarbonate) is included in the cover-forming material. Molding methods involving the use of such a chemical blowing agent require close control of the temperature, pressure and equipment systems during molding. Also, obtaining a foam body that is uniform throughout the interior of the cover or other golf ball member is very difficult. In addition, in most foam molding methods, a skin layer forms at the surface of the member, making it necessary to, for example, abrade the surface of the foamed golf ball cover in order to remove the skin layer and expose the foam face at the ball surface. The cover surface in golf balls produced by such a method often is not a uniform foam body, making it difficult to supply, in golf balls for which close control of the diameter, weight and the like is required, a stable golf ball product.

### SUMMARY OF THE INVENTION

It is therefore an object of the present invention to provide a golf ball in which the controllability on approach shots and the feel at impact can be improved, which can maintain a good scuff resistance, and which moreover has a good moldability. Another object of the invention is to provide a method for manufacturing such golf balls.

As a result of extensive investigations, I have discovered that, in a golf ball having at least one layer formed of a resin composition, by preparing the resin composition so as to include as ingredients therein a polymeric material and a leachable water-soluble polymer, molding the resin composition to obtain a solid molded body and then partially leaching out and removing the water-soluble polymer so as to render a layer formed of the resin composition into a molded body having porosity, when the resulting layer is employed as a cover layer of the golf ball, the ball has a controllability and a feel at impact on approach shots that are excellent, can maintain a good scuff resistance, and has a good moldability.

Accordingly, in a first aspect, the invention provides a golf ball which has at least one resin layer having porosity, wherein the resin layer is formed of a resin composition containing a polymeric material and a leachable water-soluble polymer.

In a preferred embodiment of the golf ball according to the first aspect of the invention, the polymeric material is polyurethane or polyurea.

In another preferred embodiment of the inventive golf ball, the water-soluble polymer has a softening point of less than 100° C.

In yet another preferred embodiment, the water-soluble polymer has a decomposition onset temperature of at least 180° C.

In still another preferred embodiment, the water-soluble polymer is nonionic.

In a further preferred embodiment, the water-soluble polymer is of at least one type selected from the group consisting of cellulose, starch, saccharides, seaweeds, plant mucilage, microbial mucilage, protein, polyvinyl alcohol, polyethylene oxide, polypropylene oxide, allyl glycidyl ether, phenyl glycidyl ether, sodium polyacrylate, polyacrylamide, polyethyleneimine, polyvinyl pyrrolidone, and polymers, random copolymers and hydrates thereof.

In a still further preferred embodiment, the water-soluble polymer is included in an amount of not more than 400 parts by weight per 100 parts by weight of the polymeric material.

In a yet further preferred embodiment, the water-soluble polymer has a weight-average molecular weight of not more than 7,000,000.

In another preferred embodiment, the resin layer with porosity has a rebound resilience as measured according to JIS-K 6255: 2013 which is from 10 to 70%.

In still another preferred embodiment, the resin layer with porosity has a specific gravity within the range of 1.0 to 1.3.

In a second aspect, the invention provides a method for manufacturing golf balls, which method includes the steps of: molding a resin composition containing a polymeric material and a water-soluble polymer to give a solid molded body; and then partially leaching out and removing the water-soluble polymer.

### Advantageous Effects of the Invention

By virtue of the inventive golf ball and method of manufacture thereof, there can be obtained golf balls which have an improved controllability on approach shots and an improved feel at impact, maintain a good scuff resistance and moreover have a good moldability. This invention is especially suitable for obtaining golf balls that are easy to control on approach shots.

### DESCRIPTION OF THE PREFERRED EMBODIMENTS

The objects, features and advantages of the invention will become more apparent from the following detailed description.

The golf ball of the invention has at least one resin layer with porosity, which resin layer is formed of a resin composition containing a polymeric material and a leachable water-soluble polymer.

The polymeric material serves as the base resin of the resin composition. Although not particularly limited, it may be suitably selected from among known rubber materials, thermoplastic resins, thermoplastic elastomers, thermoset resins and thermoset elastomers. Examples of resin materials that may be used include thermoplastic or thermoset polyurethane elastomers, polyester elastomers, ionomeric resins, polyolefin elastomers and polyureas.

These may be used singly or two or more may be used in admixture. In those cases in particular where the resin material is to be used as an encasing member such as a golf ball cover, preferred use can be made of a polyurethane or a polyurea.

The rubber material can be obtained by vulcanizing a rubber composition containing a base rubber as the chief component. This rubber material is formed using a rubber composition containing, for example, a base rubber, a co-crosslinking agent, a crosslink initiator, a metal oxide and an antioxidant. It is preferable to use polybutadiene as the base rubber of the rubber composition.

The polyurethane and polyurea are described in detail below.

### Polyurethane

The polyurethane has a structure which includes soft segments composed of a polymeric polyol (polymeric glycol) that is a long-chain polyol, and hard segments composed of a chain extender and a polyisocyanate. Here, the polymeric polyol serving as a starting material may be any that has hitherto been used in the art relating to polyurethane materials, and is not particularly limited. This is exemplified by polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. Specific examples of polyester polyols that may be used include adipate-type polyols such as polyethylene adipate glycol, polypropylene adipate glycol, polybutadiene adipate glycol and polyhexamethylene adipate glycol; and lactone-type polyols such as polycaprolactone polyol. Examples of polyether polyols include poly(ethylene glycol), poly(propylene glycol), poly(tetramethylene glycol) and poly(methyltetramethylene glycol). Such long-chain polyols may be used singly, or two or more may be used in combination.

The long-chain polyol preferably has a number-average molecular weight in the range of 1,000 to 5,000. By using a long-chain polyol having a number-average molecular weight in this range, golf balls which are made with a polyurethane composition and have excellent properties, including a good rebound and a good productivity, can be reliably obtained. The number-average molecular weight of the long-chain polyol is more preferably in the range of 1,500 to 4,000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used. In this invention, low-molecular-weight compounds with a molecular weight of 2,000 or less which have on the molecule two or more active hydrogen atoms capable of reacting with isocyanate groups may be used. Of these, preferred use can be made of aliphatic diols having from 2 to 12 carbon atoms. Specific examples include 1,4-butylene glycol, 1,2-ethylene glycol, 1,3-butanediol, 1,6-hexanediol and 2,2-dimethyl-1,3-propanediol. Of these, the use of 1,4-butylene glycol is especially preferred.

Any polyisocyanate hitherto employed in the art relating to polyurethanes may be suitably used without particular limitation as the polyisocyanate. For example, use can be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, 1,4-bis(isocyanatomethyl)cyclohexane and dimer acid diisocyanate. However, depending on the type of isocyanate, crosslinking reactions during injection molding may be difficult to control.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method for preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

It is preferable to use a thermoplastic polyurethane material as the polyurethane. The thermoplastic polyurethane material may be a commercial product, examples of which include those available as Pandex® from DIC Covestro Polymer, Ltd., and those available under the brand name Resamine from Dainichiseika Color & Chemicals Mfg. Co., Ltd.

### Polyurea

The polyurea is a resin composition composed primarily of urea linkages formed by reacting (i) an isocyanate with (ii) an amine-terminated compound. This resin composition is described in detail below.

### (i) Isocyanate

Suitable use can be made here of an isocyanate that is used in the prior art relating to polyurethanes, although the isocyanate is not particularly limited. Use may be made of isocyanates similar to those mentioned above in connection with the polyurethane material.

### (ii) Amine-Terminated Compound

An amine-terminated compound is a compound having an amino group at the end of the molecular chain. In this invention, the long-chain polyamines and/or amine curing agents shown below may be used.

A long-chain polyamine is an amine compound which has on the molecule at least two amino groups capable of reacting with isocyanate groups and which has a number-average molecular weight of from 1,000 to 5,000. In this invention, the number-average molecular weight is more preferably from 1,500 to 4,000, and even more preferably from 1,900 to 3,000. Examples of such long-chain polyamines include, but are not limited to, amine-terminated hydrocarbons, amine-terminated polyethers, amine-terminated polyesters, amine-terminated polycarbonates, amine-terminated polycaprolactones, and mixtures thereof. These long-chain polyamines may be used singly, or two or more may be used in combination.

An amine curing agent is an amine compound which has on the molecule at least two amino groups capable of reacting with isocyanate groups and which has a number-average molecular weight of less than 1,000. In this invention, the number-average molecular weight is more preferably less than 800, and even more preferably less than 600. Specific examples of such amine curing agents include, but are not limited to, ethylenediamine, hexamethylenediamine, 1-methyl-2,6-cyclohexyldiamine, tetrahydroxypropylene ethylenediamine, 2,2,4- and 2,4,4-trimethyl-1,6-hexanediamine, 4,4′-bis(sec-butylamino)dicyclohexylmethane, 1,4-bis(sec-butylamino)cyclohexane, 1,2-bis(sec-butylamino)cyclohexane, derivatives of 4,4′-bis(sec-butylamino)dicyclohexylmethane, 4,4′-dicyclohexylmethanediamine, 1,4-cyclohexane bis(methylamine), 1,3-cyclohexane bis(methylamine), diethylene glycol di(aminopropyl) ether, 2-methylpentamethylenediamine, diaminocyclohexane, diethylenetriamine, triethylenetetramine, tetraethylenepentamine, propylenediamine, 1,3-diaminopropane, dimethylaminopropylamine, diethylaminopropylamine, dipropylenetriamine, imidobis(propylamine), monoethanolamine, diethanolamine, triethanolamine, monoisopropanolamine, diisopropanolamine, isophoronediamine, 4,4′-methylenebis(2-chloroaniline), 3,5-dimethylthio-2,4-toluenediamine, 3,5-dimethylthio-2,6-toluenediamine, 3,5-diethylthio-2,4-toluenediamine, 3,5-diethylthio-2,6-toluenediamine, 4,4′-bis(sec-butylamino)diphenylmethane and derivatives thereof, 1,4-bis(sec-butylamino)benzene, 1,2-bis(sec-butylamino)benzene, N,N′-dialkylaminodiphenylmethane, N,N,N′,N′-tetrakis(2-hydroxypropyl)ethylenediamine, trimethylene glycol di-p-aminobenzoate, polytetramethylene oxide di-p-aminobenzoate, 4,4′-methylenebis(3-chloro-2,6-diethyleneaniline), 4,4′-methylenebis(2,6-diethylaniline), m-phenylenediamine, p-phenylenediamine and mixtures thereof. These amine curing agents may be used singly or two or more may be used in combination.

(iii) Polyol

Although not an essential ingredient, in addition to above components (i) and (ii), a polyol may also be included in the polyurea. The polyol is not particularly limited, but is preferably one that has hitherto been used in the art relating to polyurethanes. Specific examples include the long-chain polyols and/or polyol curing agents mentioned below.

Any long-chain polyol that has hitherto been used in the art relating to polyurethanes may be suitably used without particular limitation. Examples include, but are not limited to, polyester polyols, polyether polyols, polycarbonate polyols, polyester polycarbonate polyols, polyolefin-based polyols, conjugated diene polymer-based polyols, castor oil-based polyols, silicone-based polyols and vinyl polymer-based polyols. These long-chain polyols may be used singly or two or more may be used in combination.

The long-chain polyol has a number-average molecular weight of preferably from 1,000 to 5,000, and more preferably from 1,700 to 3,500. In this number-average molecular weight range, an even better resilience and productivity are obtained.

Any polyol curing agent that has hitherto been used in the art relating to polyurethanes may be suitably used without particular limitation. In this invention, use may be made of a low-molecular-weight compound having on the molecule at least two active hydrogen atoms capable of reacting with isocyanate groups and having a molecular weight of less than 1,000. Of these, the use of aliphatic diols having from 2 to 12 carbon atoms is preferred. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred. The polyol curing agent has a number-average molecular weight of preferably less than 800, and more preferably less than 600.

A known method may be used to produce the polyurea. A prepolymer process, a one-shot process or some other known method may be suitably selected for this purpose.

When the above polyurethane or other resin is used as the base resin, the content thereof is suitably selected according to the required properties of the desired manufactured article. The lower limit is at least 50 wt %, preferably at least 60 wt %, and more preferably at least 80 wt %, per 100 wt % of the composition.

The resin composition includes, together with the above-described polymeric material, a leachable water-soluble polymer. This water-soluble polymer has a softening point which is preferably less than 100° C. because a polymer with a lower softening point generally leaches out more readily and it is desirable for the polymer to readily dissolve at the water temperature. This softening point can be checked by measuring the glass transition temperature with a differential scanning calorimeter (DSC).

The water-soluble polymer has a decomposition onset temperature that is preferably at least 180° C., more preferably at least 200° C., and even more preferably at least 210° C. In order to keep the water-soluble polymer from decomposing at the polymeric material molding temperature, it is preferable for this decomposition onset temperature to be higher than the molding temperature of the polymeric material. For example, when forming the cover of a golf ball, although the molding conditions differ with the cover material, given that the molding temperature in the case of a urethane resin material is generally between 150 and 270° C., water-soluble polymers having a decomposition onset temperature that is higher than the likely temperature setting during molding include polyvinyl alcohol and polyethylene oxide.

The water-soluble polymer has a weight-average molecular weight (Mw) which is preferably not more than 7,000,000, more preferably not more than 1,000,000, and even more preferably of more than 500,000. The weight-average molecular weight (Mw) is a polystyrene-equivalent value obtained by gel permeation chromatography (GPC).

The water-soluble polymer, in order to enable it to be easily leached and removed after molding, has a solubility per 100 g of water at 20° C. that is preferably at least 1 g, more preferably at least 5 g, and even more preferably at least 10 g.

The water-soluble polymer is preferably nonionic for such reasons as to minimize the influence of water hardness during leaching, to prevent the staining and corrosion of equipment, and to prevent unintended reactions with the resin material.

Exemplary water-soluble polymers include primarily natural polymers such as starches and saccharides, semi-synthetic polymers such as cellulose, and synthetic polymers such as sodium polyacrylate and polyvinyl alcohol. In this invention, a compound which does not decompose at the thermoplastic resin molding/processing temperature and which, after molding, can be easily extracted with water is suitable.

Specific examples of water-soluble polymers that may be selected for use here include cellulose, starch, saccharides, seaweeds, plant mucilage, microbial mucilage, protein, polyvinyl alcohol, polyalkylene oxides such as polyethylene oxide and polypropylene oxide, allyl glycidyl ether, phenyl glycidyl ether, sodium polyacrylate, polyacrylamide, polyethyleneimine, polyvinyl pyrrolidone, and polymers, random copolymers and hydrates of these. Any one from this group may be used alone, or two or more may be used in admixture. It is especially preferable to use a water-soluble thermoplastic resin as the water-soluble polymer. Specifically, suitable use may be made of, for example, polyalkylene oxides such as polyethylene oxide and polypropylene oxide, as well as copolymers thereof, and polyvinyl alcohol.

A commercial product may be used as the water-soluble thermoplastic resin.

Examples of polyvinyl alcohols (PVA) include those available as Kuraray Poval™ and Mowiflex™ from Kuraray Co., Ltd., POVAL from Japan Vam & Poval Co., Ltd., and Gohsenol™ from Mitsubishi Chemical Corporation. Examples of polyethylene oxides (PEO) include those available as Alkox® from Meisei Chemical Works, Ltd., and PEO from Sumitomo Seika Chemicals Co., Ltd.

The amount of the water-soluble polymer included when formulating the resin composition is suitably selected according to the porous morphology—such as the number, quantity and size of the pores—desired in the porous body as a golf ball member, but is preferably not more than 400 parts by weight per 100 parts by weight of the polymeric material. For example, when the porous body is to be used as a golf ball cover, from the standpoint of the desired feel at impact and controllability on approach shots, the amount included per 100 parts by weight of polyurethane resin is preferably not more than 400 parts by weight, more preferably not more than 100 parts by weight, even more preferably not more than 50 parts by weight, and most preferably not more than 20 parts by weight. The lower limit in the polymer content is preferably at least 1 part by weight.

In addition, various additives other than the above ingredients may be optionally included in the resin composition. For example, pigments, dispersants, antioxidants, light stabilizers, ultraviolet absorbers and internal mold lubricants may be suitably included. Various types of blowing agents such as chemical blowing agents are not included in this invention.

The resin composition can be obtained by mixing together and incorporating the above ingredients using any of various types of mixers, such as a kneading-type single-screw or twin-screw extruder, a Banbury mixer or a kneader.

In the method for manufacturing golf balls of the invention, by molding a resin composition containing a polymeric material and a water-soluble polymer to give a solid molded body and then partially leaching out and removing the water-soluble polymer, a molded body having an open-cell or closed-cell porous body (foam body) in which the particle shapes of the water-soluble polymer have become cells (pores) is obtained. The molded body or layer having this porous body (foam body) is sometimes referred to below as simply the “porous molded body” or the “porous layer.”

The method used to mold the resin composition may entail, for example, feeding the resin composition to an injection molding machine and injecting the molten resin composition over the core so as to mold a cover. In this case, the molding temperature varies with the resin composition that is used; for polyurethane or polyurea, the molding temperature is typically in the range of 150 to 270° C. Another method that may be used is one in which the molten resin composition is shaped by pressing within a mold so as to obtain foam-molded bodies in the shape of half-cups, following which the core is enveloped by two such foam-molded half-cups and heat and pressure are applied in a press or the like, thereby forming a golf ball cover.

The water-soluble polymer included in the molded material thus obtained from the resin composition is subsequently leached out and removed. The specific method for doing so, although not particularly limited, involves leaching out the water-soluble polymer with water having a temperature of between about 5° C. and about 100° C., preferably between about 10° C. and about 80° C., and more preferably between about 20° C. and about 60° C. From the standpoint of the efficiency of the operation, it is preferable for the water-soluble polymer to be capable of being leached out and removed in a short time at a high temperature, such as by immersion for a length of time during which the water-soluble polymer can be fully leached out and removed with water at the above temperature, the length of time being typically from 5 minutes to 12 hours, preferably from 10 minutes to 8 hours, and more preferably from 20 minutes to 4 hours. Methods for accelerating such leaching and removal may also be suitably selected and added. Examples include, but are not limited to, physical methods of removal such as shaking, stirring, rocking, aeration, microbubbles, ultrasound, high-pressure spraying and brushing. After the water-soluble polymer has been leached out and removed, the porous molded body can be obtained by thorough drying. The specific drying method used is not particularly limited, although the porous molded body desired can be obtained after adhering water is thoroughly removed by using a dryer or a dehumidifying dryer to carry out drying at a temperature of, for example, up to 120° C., preferably up to 80° C., and more preferably up to 60° C.

The morphology of the cells in the porous molded body obtained from the resin composition is suitably selected according to the type and content of the water-soluble polymer included in the polymer material. For example, in cases where the water-soluble polymer is mixed into polyurethane, the resulting composition is molded as a golf ball cover material and the water-soluble polymer is subsequently leached out with cold or hot water, at a low water-soluble polymer content, only the water-soluble polymer present at the surface of the golf ball cover leaches out and pore formation occurs only at the surface, with water-soluble polymer remaining behind at the interior. On the other hand, at a high water-soluble polymer content, the water-soluble polymer is continuously present within the resin composition and contiguously leaches out, forming an open-cell porous body, with substantially all of the water-soluble polymer leaching out and being removed. It should be noted, however, that the water-soluble polymer, which has become even finer due to shear stresses, etc. that are applied when incorporating the water-soluble polymer into the polyurethane and when molding golf ball covers (as the resin molded material) from the polyurethane and water-soluble polymer-containing resin composition, is taken up within the urethane. Some of this water-soluble polymer that has been taken up within the urethane does not come into contact with water and thus remains behind.

To both maintain a good scuff resistance and reduce the initial velocity on approach shots, the porous molded body has a specific gravity which is preferably between 1.0 and 1.3. In cases where the desired properties include a softer feel at impact and a greater softness of appearance, the specific gravity is more preferably 1.0 or less.

The porous molded body has a rebound resilience, as measured according to JIS-K 6255: 2013, which is preferably at least 11%, more preferably at least 30%, and even more preferably at least 40%. The upper limit value is preferably not more than 70%, more preferably not more than 68%, and even more preferably not more than 64%. Too low a rebound resilience may be detrimental to the initial velocity and distance of the ball on shots with a driver. On the other hand, when the rebound resilience is too high, the ball rebound may rise, the ball controllability on approach shots may worsen and miss-hit shots may increase or the ball may fly farther than anticipated, in addition to which the desired spin rate may not be achievable.

The resin composition has a material hardness on the Shore D hardness scale which, from the standpoint of the spin performance on approach shots, is not more than 60, preferably not more than 55, and more preferably not more than 50. The lower limit value, from the standpoint of the moldability, is preferably at least 30, and more preferably at least 35.

The porous molded body obtained as described above can be employed as at least one layer serving as a golf ball member—namely the core and the cover layers encasing the core (which cover layers are also called the intermediate layer, envelope layer, outermost layer, etc.). In particular, use as a cover layer in a golf ball having a core and at least one cover layer is preferred, and use as the outermost cover layer is more preferred.

### EXAMPLES

The following Examples and Comparative Examples are provided to illustrate the invention, and are not intended to limit the scope thereof.

### Examples 1 to 24, Comparative Example 1

A golf ball core-forming rubber composition formulated as shown in Table 1 and common to all of the Examples was prepared and then molded and vulcanized to produce a 38.6 mm diameter core.

TABLE 1

| | parts by |
|---|---|
| Rubber composition | weight |
| cis-1,4-Polybutadiene | 100 |
| Zinc acrylate | 27 |
| Zinc oxide | 4.0 |
| Barium sulfate | 16.5 |
| Antioxidant | 0.2 |
| Organic peroxide (1) | 0.6 |
| Organic peroxide (2) | 1.2 |
| Zinc salt of pentachlorothiopbenol | 0.3 |
| Zinc stearate | 1.0 |

Details on the above core material are given below.

cis-1,4-Polybutadiene: Available under the trade name “BR 01” from JSR Corporation Zinc acrylate: From Nippon Shokubai Co., Ltd.
Zinc oxide: From Sakai Chemical Co., Ltd.
Barium sulfate: From Sakai Chemical Co., Ltd.
Antioxidant: Available under the trade name “Nocrac NS6” from Ouchi Shinko Chemical Industry Co., Ltd.
Organic peroxide (1): Dicumyl peroxide, available as “Percumyl® D” from NOF Corporation
Organic peroxide (2): A mixture of 1,1-di(tert-butylperoxy)cyclohexane and silica, available as “Perhexa® C-40” from NOF Corporation
Zinc stearate: Available from NOF Corporation

Next, an intermediate layer-forming resin material common to all of the Examples was formulated. This intermediate layer resin material was a blend of 50 parts by weight of a sodium-neutralized ethylene-unsaturated carboxylic acid copolymer having an acid content of 18 wt % and 50 parts by weight of a zinc-neutralized ethylene-unsaturated carboxylic acid copolymer having an acid content of 15 wt % (for a combined amount of 100 parts by weight). This resin material was injection-molded over a core having a diameter of 38.6 mm, thereby producing an intermediate layer-encased sphere having an intermediate layer with a thickness of 1.25 mm.

### Preparation of Cover-Forming Resin Composition

In all of the Examples, an ether-type thermoplastic polyurethane (Shore D hardness, 40) available as “Pandex®” from DIC Covestro Polymer, Ltd. was used as the thermoplastic polyurethane elastomer. The cover-forming resin compositions in the respective Examples were prepared by blending the three kinds of water-soluble polymer shown in Table 2 below in the amounts shown in Tables 3 to 5 with 100 parts by weight of this thermoplastic polyurethane elastomer.

### Three Kinds of Water-Soluble Polymer

Grade C500T: A polyvinyl alcohol available under the trade name “Mowiflex™” from Kuraray Co., Ltd.
Grade EP1010N: An ethylene oxide/propylene oxide random copolymer available as “Alkox®” from Meisei Chemical Works, Ltd.
Grade CP-A1H: An ethylene oxide/propylene oxide/allyl glycidyl ether random copolymer available as “Alkox®” from Meisei Chemical Works, Ltd.

The properties of these water-soluble polymers are shown below in Table 2.

TABLE 2

| | Grade | Grade | Grade |
|---|---|---|---|
| | C500T | EP1010N | CP-A1H |
| Formulation | Polyvinyl | Ethylene oxide/ | Ethylene oxide/ |
| | alcohol | propylene oxide | propylene oxide/ |
| | (PVA) | random | allyl glycidyl ether |
| | | copolymer | random polymer |
| Softening point (° C.) | 42 | 30 to 50 | 30 to 50 |
| Decomposition onset | 257 | 210 | 210 |
| temperature (° C.) | | | |
| Weight-average | — | approx. 100,000 | approx. 100,000 |
| molecular weight (Mw) | | | |
| Solubility | ≥10 g | ≥10 g | ≥10 g |
| (g/100 g of H₂O) | | | |

### Fabrication of Sheet Samples for Evaluation

The resin compositions in Tables 3 to 5 below were kneaded in a mixer, following which they were formed into 2 mm thick sheets by pressing with a heated press. The sheets were immersed for four hours in hot water having a temperature of 55° C. and then dried for 12 hours at 55° C., thereby obtaining porous resin sheet samples. The rebound resilience and specific gravity were determined using the porous resin sheet samples in the respective Examples. Measurement of the rebound resilience was based on JIS-K 6255: 2013.

### Production of Golf Balls

The intermediate layer-encased sphere described above (diameter, 41.1 mm; weight, 40.6 g) was peripherally encased by the resin composition in the respective Examples. The resulting sphere encased by a cover (outermost layer) having a thickness after molding the resin composition of 0.8 mm was subsequently immersed for four hours in hot water having a temperature of 55° C. and then dried at 55° C. for 12 hours. The cover-encased sphere thus obtained was then painted, thereby producing a three-piece golf ball having a diameter of 42.7 mm.

The golf balls produced as described above in the respective Examples were evaluated by the following methods for feel at impact, scuff resistance, moldability, and ball initial velocity and controllability on approach shots. The results are shown in Tables 3 to 5.

### Initial Velocity of Ball on Approach Shots

A sand wedge (SW) was mounted on a golf swing robot, and the initial velocity of the ball immediately after being struck at a head speed (HS) of 20 m/s was measured with an apparatus for measuring the initial conditions. The amount of decrease in the ball initial velocity (ΔV) in each Example was calculated relative to the initial velocity of the ball in Comparative Example 1.

### Controllability on Approach Shots

Sensory evaluations of the ball controllability on approach shots were carried out as follows. The club used was a sand wedge (SW).

Excellent (Exc): Controllability was very good.

Good: Controllability was good.

No Good (NG): Controllability was somewhat poor.

### Feel on Approach Shots

Sensory evaluations of the ball feel at impact on approach shots were carried out as follows. The club used was a sand wedge (SW).

Excellent (Exc): Very soft feel at impact; easy to feel the sweet spot.

Good: Soft feel at impact; easy to feel the sweet spot.

No Good (NG): Rapid ball separation from club; cannot feel the sweet spot.

### Scuff Resistance

The golf balls were held isothermally at 23° C. and five balls of each type were hit at a head speed of 33 m/s using as the club a pitching wedge mounted on a swing robot machine. The damage to the ball from the impact was visually rated according to the following criteria.

Excellent (Exc): Slight scuffing or substantially no apparent scuffing.

Good: Slight fraying of surface or slight dimple damage.

No Good (NG): Dimples completely obliterated in places.

### Moldability

The moldability was evaluated by visually rating the golf ball appearance according to the following criteria.
Excellent (Exc): No features whatsoever other than dimple shapes (e.g., wrinkles, ripples) are apparent on cover surface.
Good: Substantially no features other than dimple shapes (e.g., wrinkles, ripples) are apparent on cover surface.
No Good (NG): Features other than dimple shapes (e.g., wrinkles, ripples) are apparent on cover surface, or underlying material is visible.

TABLE 3

| | | | Comp. | | | | | | | | |
|---|---|---|---|---|---|---|---|---|---|---|---|
| | | | Ex. | Example | | | | | | | |
| | | | 1 | 1 | 2 | 3 | 4 | 5 | 6 | 7 | 8 |
| Resin | Formulation | Polymeric material TPU | 100 | 100 | 100 | 100 | 100 | 100 | 100 | 100 | 100 |
| Com- | (pbw) | Water-soluble polymer C500T | | 3 | 5 | 10 | 20 | 50 | 100 | 200 | 400 |
| position | | Water-soluble polymer EP1010N | | | | | | | | | |
| | | Water-soluble polymer CP-A1H | | | | | | | | | |
| Porous | Properties | Specific gravity | 1.12 | 1.12 | 1.13 | 1.13 | 1.15 | 1.17 | 1.20 | 1.22 | 1.24 |
| molded | | Rebound resilience (%) | 65 | 63 | 62 | 60 | 55 | 45 | 35 | 25 | 17 |
| body | | Rebound resilience ΔE | 0 | −2 | −3 | −5 | −10 | −20 | −30 | −40 | −48 |
| | | (vs. Comparative Example 1) | | | | | | | | | |

| | | | | | | | | | | |
|---|---|---|---|---|---|---|---|---|---|---|
| Eval- | Initial velocity (m/s) | 19.08 | 19.07 | 19.06 | 19.04 | 19.03 | 18.95 | 18,84 | 18.65 | 18.52 |
| uation | Initial velocity ΔV (vs. Comparative Example 1) | 0.00 | −0.01 | −0.02 | −0.04 | −0.05 | −0.13 | −0.24 | −0.43 | −0.56 |
| results | Controllability | NG | good | Exc | Exc | Exc | Exc | Exc | Exc | Exc |
| | Feel at impact | NG | good | Exc | Exc | Exc | Exc | Exc | Exc | Exc |
| | Scuff resistance | Exc | Exc | Exc | Exc | Exc | Exc | good | good | good |
| | Moidability | Exc | Exc | Exc | Exc | Exc | good | good | good | good |

TABLE 4

| | | | Example | | | | | | | |
|---|---|---|---|---|---|---|---|---|---|---|
| | | | 9 | 10 | 11 | 12 | 13 | 14 | 15 | 16 |
| Resin | Formulation | Polymeric material TPU | 100 | 100 | 100 | 100 | 100 | 100 | 100 | 100 |
| Com- | (pbw) | Water-soluble polymer C500T | | | | | | | | |
| position | | Water-soluble polymer EP1010N | 3 | 5 | 10 | 20 | 50 | 100 | 200 | 400 |
| | | Water-soluble polymer CP-A1H | | | | | | | | |
| Porous | Properties | Specific gravity | 1.12 | 1.12 | 1.12 | 1.12 | 1.13 | 1.13 | 1.14 | 1.14 |
| molded | | Rebound resilience (%) | 64 | 61 | 62 | 59 | 53 | 46 | 40 | 35 |
| body | | Rebound resilience ΔE | −1 | −2 | −3 | −6 | −12 | −18 | −25 | −30 |
| | | (vs. Comparative Example 1) | | | | | | | | |

| | | | | | | | | | |
|---|---|---|---|---|---|---|---|---|---|
| Eval- | Initial velocity (m/s) | 19.02 | 18.98 | 18.98 | 18.97 | 18.74 | 18.59 | 18.40 | 18.26 |
| uation | Initial velocity ΔV (vs. Comparative Example 1) | −0.06 | −0.10 | −0.10 | −0.11 | −0.34 | −0.49 | −0.68 | −0.82 |
| results | Controllability | good | Exc | Exc | Exc | Exc | Exc | Exc | Exc |
| | Feel at impact | good | Exc | Exc | Exc | Exc | Exc | Exc | Exc |
| | Scuff resistance | Exc | Exc | Exc | Exc | Exc | good | good | good |
| | Moldability | Exc | Exc | Exc | Exc | good | good | good | good |

TABLE 5

| | | | Example | | | | | | | |
|---|---|---|---|---|---|---|---|---|---|---|
| | | | 17 | 18 | 19 | 20 | 21 | 22 | 23 | 24 |
| Resin | Formulation | Polymeric material TPU | 100 | 100 | 100 | 100 | 100 | 100 | 100 | 100 |
| Com- | (pbw) | Water-soluble polymer C500T | | | | | | | | |
| position | | Water-soluble polymer EP1010N | | | | | | | | |
| | | Water-soluble polymer CP-A1H | 3 | 5 | 10 | 20 | 50 | 100 | 200 | 400 |
| Porous | Properties | Specific gravity | 1.12 | 1.12 | 1.12 | 1.12 | 1.13 | 1.13 | 1.14 | 1.14 |
| molded | | Rebound resilience (%) | 64 | 63 | 62 | 59 | 53 | 46 | 40 | 35 |
| body | | Rebound resilience ΔE | −1 | −2 | −3 | −6 | −12 | −18 | −25 | −30 |
| | | (vs. Comparative Example 1) | | | | | | | | |

| | | | | | | | | | |
|---|---|---|---|---|---|---|---|---|---|
| Eval- | Initial velocity (m/s) | 19.04 | 19.04 | 19.03 | 18.99 | 18.92 | 18.71 | 18.55 | 18.45 |
| uation | Initial velocity ΔV (vs. Comparative Example 1) | −0.04 | −0.04 | −0.05 | −0.09 | −0.16 | −0.37 | −0.53 | −0.63 |
| results | Controllability | good | Exc | Exc | Exc | Exc | Exc | Exc | Exc |
| | Feel at impact | good | Exc | Exc | Exc | Exc | Exc | Exc | Exc |
| | Scuff resistance | Exc | Exc | Exc | Exc | Exc | good | good | good |
| | Moldability | Exc | Exc | Exc | Exc | good | good | good | good |

Japanese Patent Application No. 2020-101512 is incorporated herein by reference.

Although some preferred embodiments have been described, many modifications and variations may be made thereto in light of the above teachings. It is therefore to be understood that the invention may be practiced otherwise than as specifically described to without departing from the scope of the appended claims.

1. A golf ball comprising at least one resin layer having porosity, wherein the resin layer is formed of a resin composition containing a polymeric material and a leachable water-soluble polymer.

2. The golf ball of claim 1, wherein the polymeric material is polyurethane or polyurea.

3. The golf ball of claim 1, wherein the water-soluble polymer has a softening point of less than 100° C.

4. The golf ball of claim 1, wherein the water-soluble polymer has a decomposition onset temperature of at least 180° C.

5. The golf ball of claim 1, wherein the water-soluble polymer is nonionic.

6. The golf ball of claim 1, wherein the water-soluble polymer is of at least one type selected from the group consisting of cellulose, starch, saccharides, seaweeds, plant mucilage, microbial mucilage, protein, polyvinyl alcohol, polyethylene oxide, polypropylene oxide, allyl glycidyl ether, phenyl glycidyl ether, sodium polyacrylate, polyacrylamide, polyethyleneimine, polyvinyl pyrrolidone, and polymers, random copolymers and hydrates thereof.

7. The golf ball of claim 1, wherein the water-soluble polymer is included in an amount of not more than 400 parts by weight per 100 parts by weight of the polymeric material.

8. The golf ball of claim 1, wherein the water-soluble polymer has a weight-average molecular weight of not more than 7,000,000.

9. The golf ball of claim 1, wherein the resin layer with porosity has a rebound resilience as measured according to JIS-K 6255: 2013 which is from 10 to 70%.

10. The golf ball of claim 1, wherein the resin layer with porosity has a specific gravity within the range of 1.0 to 1.3.

11. A method for manufacturing golf balls, which method comprises the steps of, in order:
molding a resin composition containing a polymeric material and a water-soluble polymer to give a solid molded body, and
partially leaching out and removing the water-soluble polymer.
